(19) United States
(12) Patent Application Publication
(10) Pub. No.: US 2021/0281293 A1
(43) Pub. Date: Sep. 9, 2021

(54) COMMUNICATION APPARATUS, COMMUNICATION METHOD, AND ELECTRONIC APPARATUS

(71) Applicant: SONY SEMICONDUCTOR SOLUTIONS CORPORATION, KANAGAWA (JP)

(72) Inventors: TAKAHIRO TAKEDA, KANAGAWA (JP); YASUHIRO OKADA, KANAGAWA (JP)

(21) Appl. No.: 16/328,795

(22) PCT Filed: Sep. 19, 2017
(86) PCT No.: PCT/JP2017/033651

§ 371 Date: Feb. 27, 2019

(30) Foreign Application Priority Data
Oct. 3, 2016 (JP) 2016-195527

(51) Int. Cl. H04B 5/02; H04L 5/14

(52) U.S. Cl. CPC H04B 5/02; H04L 5/14

(57) ABSTRACT

The technology relates to a communication apparatus, a communication method, and an electronic apparatus that allow for suppressing interference between signals in performing bidirectional transmission through electromagnetic coupling between two communication apparatuses. The communication apparatus includes a transmission control section that controls a method of transmission with another communication apparatus that performs the bidirectional transmission through the electromagnetic coupling on the basis of a distance from the other communication apparatus. Alternatively, the communication apparatus includes a transmission control section that controls a method of transmission with another communication apparatus on the basis of an interference level being a level of an interference component of a first signal affecting a second signal in performing transmission of the first signal and reception of the second signal through the electromagnetic coupling with the other communication apparatus. The technology is applicable to, for example, a communication apparatus that transmits a millimeter-wave signal.

### TECHNICAL FIELD

The present technology relates to a communication apparatus, a communication method, and an electronic apparatus, and more particularly to a communication apparatus, a communication method, and an electronic apparatus that perform bidirectional transmission through electromagnetic coupling.

### BACKGROUND ART

A communication system is available that performs communication with housings (apparatus bodies) brought into contact with each other or moved closer to each other between two communication apparatuses. An example of the communication system of this kind includes a communication system in which one of two communication apparatuses includes a mobile terminal apparatus, and the other includes a wireless communication apparatus called a cradle (for example, see PTL 1).

### CITATION LIST

### Patent Literature

PTL 1: Japanese Unexamined Patent Application Publication No. 2006-65700

### SUMMARY OF THE INVENTION

### Problem to be Solved by the Invention

Incidentally, in a case where bidirectional transmission is performed through electromagnetic coupling in a communication system that performs communication with housings brought into contact with each other or moved closer to each other between two communication apparatuses, there is a possibility that interference may occur between signals to be transmitted.

The present technology is intended to allow for suppressing such interference between signals in a case where the bidirectional transmission is performed between two communication apparatuses through the electromagnetic coupling.

### Means for Solving the Problem

A communication apparatus in a first aspect of the present technology includes a transmission control section that controls a method of transmission with another communication apparatus that performs bidirectional transmission through electromagnetic coupling on the basis of a distance from the other communication apparatus.

It is possible for the transmission control section to make switching between full-duplex transmission and half-duplex transmission on the basis of a distance from the other communication apparatus.

It is possible for the transmission control section to make switching, on the basis of a distance from the other communication apparatus, between full-duplex transmission in which a transmitting frequency and a receiving frequency are in the same predetermined frequency band and full-duplex transmission in which a transmitting frequency and a receiving frequency are separated within the predetermined frequency band.

It is possible for the transmission control section to make switching, on the basis of a distance from the other communication apparatus, between full-duplex transmission that transmits a two-channel signal using a first polarized wave and a second polarized wave that differ from each other and receives a two-channel signal using the first polarized wave and the second polarized wave, and full-duplex transmission that transmits a single-channel signal using the first polarized wave and receives a single-channel signal using the second polarized wave.

It is possible to provide a connector, a transmitting section that performs signal transmission through the connector, and a receiving section that performs signal reception through the connector, and it is possible for the transmission control section to control a method of transmission with the other communication apparatus on the basis of a distance between the connector and a connector of the other communication apparatus.

It is possible for the connector to be a waveguide that includes a first waveguide path and a second waveguide path, and it is possible for the transmitting section to perform signal transmission through the first waveguide path, and for the receiving section to perform signal reception through the second waveguide path.

It is possible to further provide a measuring section that measures a distance from the other communication apparatus.

It is possible for a signal that is to be transmitted to and from the other communication apparatus to be a millimeter-wave band signal.

A communication method in the first aspect of the present technology causes a communication apparatus to control a method of transmission with another communication apparatus that performs bidirectional transmission through electromagnetic coupling on the basis of a distance from the other communication apparatus.

An electronic apparatus in a second aspect of the present technology includes a transmission control section that controls a method of transmission with another communication apparatus that performs bidirectional transmission through electromagnetic coupling on the basis of a distance from the other communication apparatus.

A communication apparatus in a third aspect of the present technology includes a transmission control section that controls a method of transmission with another communication apparatus on the basis of an interference level that is a level of an interference component of a first signal affecting a second signal in a case of performing transmission of the first signal and reception of the second signal through electromagnetic coupling with the other communication apparatus.

It is possible for the transmission control section to make switching between full-duplex transmission and half-duplex transmission on the basis of the interference level.

It is possible for the transmission control section to make switching, on the basis of the interference level, between full-duplex transmission in which a transmitting frequency and a receiving frequency are in the same predetermined frequency band and full-duplex transmission in which a transmitting frequency and a receiving frequency are separated within the predetermined frequency band.

It is possible for the transmission control section to make switching, on the basis of the interference level, between full-duplex transmission that transmits a two-channel signal using a first polarized wave and a second polarized wave that differ from each other and receives a two-channel signal using the first polarized wave and the second polarized wave, and full-duplex transmission that transmits a single-channel signal using the first polarized wave and receives a single-channel signal using the second polarized wave.

It is possible to provide a connector, a transmitting section that transmits the first signal through the connector, and a receiving section that receives the second signal through the connector.

It is possible for the connector to be a waveguide that includes a first waveguide path and a second waveguide path, and it is possible for the transmitting section to perform signal transmission through the first waveguide path, and for the receiving section to perform signal transmission through the second waveguide path.

It is possible for the receiving section to measure the interference level on the basis of a signal received through the connector.

It is possible for a signal that is to be transmitted to and from the other communication apparatus to be a millimeter-wave band signal.

A communication method in the third aspect of the present technology causes a communication apparatus to control a method of transmission with another communication apparatus on the basis of an interference level that is a level of an interference component of a first signal affecting a second signal in a case of performing transmission of the first signal and reception of the second signal through electromagnetic coupling with the other communication apparatus.

An electronic apparatus in a fourth aspect of the present technology includes a transmission control section that controls a method of transmission with another communication apparatus on the basis of an interference level that is a level of an interference component of a first signal affecting a second signal in a case of performing transmission of the first signal and reception of the second signal through electromagnetic coupling with the other communication apparatus.

In the first aspect or the second aspect of the present technology, a method of transmission with another communication apparatus that performs bidirectional transmission through electromagnetic coupling is controlled on the basis of a distance from the other communication apparatus.

In the third aspect or the fourth aspect of the present technology, in a case of performing transmission of a first signal and reception of a second signal through electromagnetic coupling with another communication apparatus, a method of transmission with the other communication apparatus is controlled on the basis of an interference level that is a level of an interference component of the first signal affecting the second signal.

### Effects of the Invention

According to the first to third aspects of the present technology, in a case where bidirectional transmission is performed through electromagnetic coupling between two communication apparatuses, it is possible to suppress interference between signals.

It is to be noted that effects described herein are not necessarily limited to the effects described above, and may be any of effects described in the present specification. Further, the effects described herein are merely exemplified and not limited thereto, and any additional effects may be provided.

### BRIEF DESCRIPTION OF DRAWINGS

FIG. 1 illustrates a configuration example of a communication system according to a first embodiment of the present technology.

FIG. 2 describes interference between transmission signals.

FIG. 3 is a flowchart that describes transmission method control processing to be executed by the communication system illustrated in FIG. 1.

FIG. 4 describes the transmission method control processing to be executed by the communication system illustrated in FIG. 1.

FIG. 5 describes a modification example of a transmission method.

FIG. 6 illustrates a configuration example of a communication system according to a second embodiment of the present technology.

FIG. 7 is a schematic view of a specific configuration of a portion of the communication system in FIG. 6.

FIG. 8 describes a transmission method.

FIG. 9 illustrates a configuration example of a communication system according to a third embodiment of the present technology.

FIG. 10 is a flowchart that describes the transmission method control processing to be executed by the communication system illustrated in FIG. 9.

### MODES FOR CARRYING OUT THE INVENTION

Hereinafter, some embodiments of the present technology (hereinafter referred to as “embodiments”) are described in detail with reference to the drawings. It is to be noted that the present technology is not limited to the embodiments, and various numerical values or materials in the embodiments are merely exemplified. In the following descriptions, the same components or components having the same functions are denoted by the same reference numerals, and overlapping descriptions are omitted where appropriate. It is to be noted that descriptions are given in the following order.
1. General Description of the Technology
2. First Embodiment (An example of controlling a transmission method using an inter-connector distance)
3. Second Embodiment (An example of using polarization multiplexing)
4. Third Embodiment (An example of controlling a transmission method using an interference level)
5. Modification Examples
6. Specific Examples of Communication System

### 1. General Description of the Technology

As a signal to be used for communication between two communication apparatuses, the present technology makes it possible to adopt a configuration of using an electromagnetic wave, particularly, a high-frequency signal such as a microwave, a millimeter wave, and a terahertz wave. A communication system using the high-frequency signal is suitable for use in transmissions such as signal transmission between a variety of units and signal transmission between circuit boards in a single unit (apparatus).

It is to be noted that, as a signal to be used for communication between two communication apparatuses, it is preferable to use a millimeter-wave band signal among the high-frequency signals. The millimeter-wave band signal is an electromagnetic wave within a frequency range of 30 [GHz] to 300 [GHz] (within a wavelength range of 1 [mm] to 10 [mm]). Signal transmission (communication) with use of the millimeter-wave band makes it possible to achieve high-speed signal transmission in the order of Gbps (for example, 5 [Gbps] or higher). Examples of signals having a need for the high-speed signal transmission in the order of Gbps may include data signals such as movie picture data and computer image data. Further, signal transmission with use of the millimeter-wave band is advantageous in that it is superior in interference resistance and that no interference is given to other electrical wiring lines in a cable connection between units.

### 2. First Embodiment

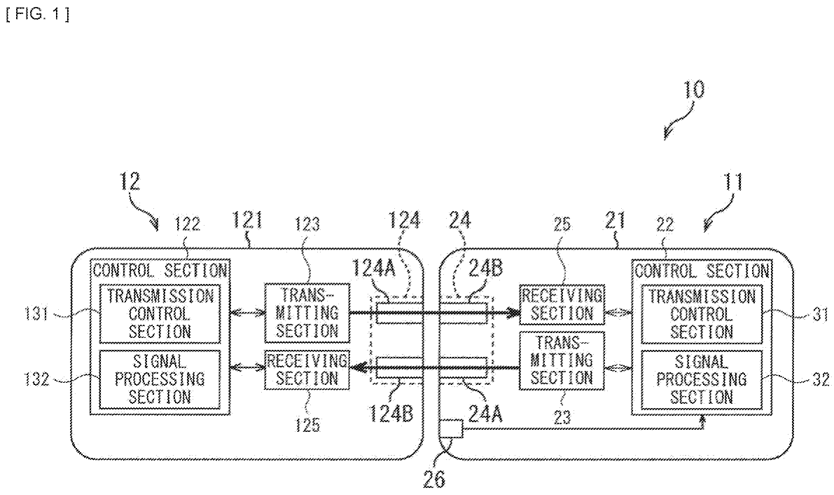

Next, description is given of a first embodiment of the present technology with reference to FIG. 1 to FIG. 5.

### <Configuration Example of First Embodiment of Communication System>

FIG. 1 is a block diagram illustrating a first embodiment of a communication system to which the present technology is applied.

A communication system 10 illustrated in FIG. 1 includes a communication apparatus 11 and a communication apparatus 12.

The communication apparatus 11 includes a control section 22, a transmitting section (hereinafter referred to as TX in some instances) 23, a connector 24, a receiving section (hereinafter referred to as RX in some instances) 25, and a distance sensor 26 inside a housing 21.

The control section 22 is configured by a processor, etc. such as a central processing unit (CPU), for example, and includes a transmission control section 31 and a signal processing section 32 as described above.

The transmission control section 31 controls signal transmission to be performed by the transmitting section 23 and the receiving section 25. For example, on the basis of a distance (hereinafter referred to as an inter-connector distance) between a connector 24 of the communication apparatus 11 and a connector 124 of the communication apparatus 12 that is measured by the distance sensor 26, the transmission control section 31 controls the transmitting section 23 and the receiving section 25 to switch transmission methods of the communication apparatus 11.

The signal processing section 32 performs a variety of signal processing operations. For example, the signal processing section 32 acquires from the receiving section 25 a signal received from the communication apparatus 12 to perform various types of processing operations on the basis of the acquired signal.

The transmitting section 23 modulates a signal supplied from the control section 22 in a predetermined method. For example, the transmitting section 23 converts the signal supplied from the control section 22 into a transmission signal composed of a millimeter-wave band ASK (Amplitude Shift Keying) modulation wave. The transmitting section 23 transmits the post-modulation transmission signal to the communication apparatus 12 through a waveguide path 24A of the connector 24.

The connector 24 includes, for example, a waveguide made of a metal material, etc. such as aluminum. Further, as described above, the connector 24 is provided with the waveguide path 24A and a waveguide path 24B. The waveguide path 24A and the waveguide path 24B are filled with a dielectric on an as-needed basis. Examples of the dielectric to be used include polytetrafluoroethylene, liquid crystalline polymer, cycloolefin polymer, polyimide, polyether ether ketone, polyphenylene sulfide, a thermosetting resin, and an ultraviolet curable resin. It is to be noted that a whole of each of the waveguide paths does not necessarily need to be filled with the dielectric, and it is sufficient that at least a portion of each of the waveguide paths, preferably at least an open end of each of the waveguide paths may be filled.

The receiving section 25 receives a transmission signal from the communication apparatus 12 through the waveguide path 24B of the connector 24. The receiving section 25 demodulates the received transmission signal into a pre-modulation signal. For example, the receiving section 25 demodulates a transmission signal composed of a millimeter-wave band ASK modulation wave into a pre-modulation signal. The receiving section 25 supplies a post-demodulation signal to the control section 22.

The distance sensor 26 measures the inter-connector distance between the connector 24 and the connector 124 of the communication apparatus 12 to supply a measuring signal indicating a measurement result to the transmission control section 31. To ensure that the inter-connector distance is measured more accurately, the distance sensor 26 is preferably disposed at a position as close as possible to a surface (hereinafter referred to as a contact surface) of the connector 24 that is brought into contact with, or is moved closer to the connector 124 of the communication apparatus 12.

The communication apparatus 12 includes a control section 122, a transmitting section 123, the connector 124, and a receiving section 125 inside a housing 121. The control section 122 includes a transmission control section 131 and a signal processing section 132. The connector 124 includes a waveguide path 124A and a waveguide path 124B.

It is to be noted that, in the communication apparatus 12, any components corresponding to those in the communication apparatus 11 are denoted by the same reference numerals in the last two digits. The communication apparatus 12 has a configuration eliminating the distance sensor 26 from the communication apparatus 11, and other components are almost similar to those in the communication apparatus 11. Therefore, detailed descriptions are omitted.

The housing 21 of the communication apparatus 11 and the housing 121 of the communication apparatus 12 are brought into contact with each other or moved closer to each other, and the contact surface of the connector 24 of the communication apparatus 11 and the contact surface of the connector 124 of the communication apparatus 12 are brought into contact with each other or moved closer to each other. This causes the connector 24 and the connector 124 to be coupled electromagnetically. This allows for signal transmission between the connector 24 and the connector 124.

More particularly, an open end of the waveguide path 24A provided on the contact surface of the connector 24 and an open end of the waveguide path 124B provided on the contact surface of the connector 124 are brought into contact with each other or moved closer to each other. This causes the waveguide path 24A and the waveguide path 124B to be coupled electromagnetically, which allows for signal transmission between the waveguide path 24A and the waveguide path 124B. Likewise, an open end of the waveguide path 24B provided on the contact surface of the connector 24 and an open end of the waveguide path 124A provided on the contact surface of the connector 124 are brought into contact with each other or moved closer to each other. This causes the waveguide path 24B and the waveguide path 124A to be coupled electromagnetically, which allows for signal transmission between the waveguide path 24B and the waveguide path 124A.

<Interference between Transmission Signals>

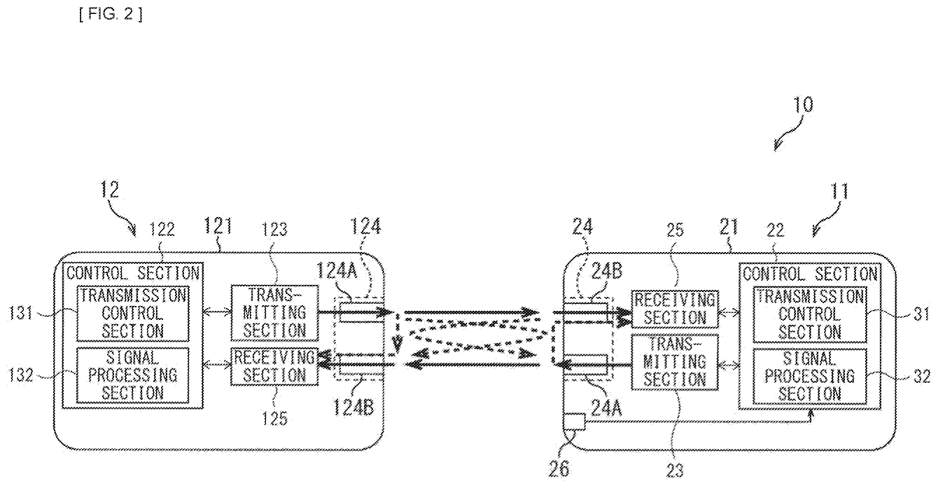

As illustrated in FIG. 2, in a case of performing full-duplex transmission in which the communication apparatus 11 and the communication apparatus 12 perform transmission/reception of transmission signals in parallel, as the inter-connector distance between the communication apparatus 11 and the communication apparatus 12 becomes longer, interference between a transmission signal to be transmitted from the communication apparatus 11 to the communication apparatus 12 (hereinafter referred to as a transmission signal A) and a transmission signal to be transmitted from the communication apparatus 12 to the communication apparatus 11 (hereinafter referred to as a transmission signal B) becomes greater.

For example, when the inter-connector distance become longer, a leaking component (hereinafter referred to as a leakage component), of the transmission signal A to be transmitted from the communication apparatus 11 to the communication apparatus 12, increases that is caused, for example, by leaking from a pathway between the waveguide path 24A and the waveguide path 124B, or by returning back to the communication apparatus 11 after being reflected by the housing 121 of the communication apparatus 12.

Likewise, when the inter-connector distance becomes longer, a leakage component, of the transmission signal B to be transmitted from the communication apparatus 12 to the communication apparatus 11, increases that is caused, for example, by leaking from a pathway between the waveguide path 124A and the waveguide path 24B, or by returning back to the communication apparatus 12 after being reflected by the housing of the communication apparatus 11.

When the leakage component in the transmission signal A becomes greater, a component to be received by the communication apparatus 12 in the transmission signal A decreases. Further, a component (hereinafter referred to as an interference component), of the transmission signal A, to be received by the communication apparatus 11 through the waveguide path 24B increases.

Likewise, when the leakage component of the transmission signal B becomes greater, a component, of the transmission signal B, to be received by the communication apparatus 11 decreases. Further, an interference component, of the transmission signal B, to be received by the communication apparatus 12 through the waveguide path 124B increases.

Accordingly, as the inter-connector distance becomes longer, and as the leakage components of the transmission signal A and the transmission signal B further increase, a ratio of the transmission signal B, of a transmission signal received by the communication apparatus 12, increases that is an interference component affecting the nominal transmission signal A. Likewise, a ratio of the transmission signal A, of a transmission signal received by the communication apparatus 11, increases that is an interference component affecting the nominal transmission signal B. This results in deterioration in quality of a transmission signal or in inability to transmit the transmission signal.

The communication system 10 suppresses such interference between the transmission signals.

### <Transmission Method Control Processing>

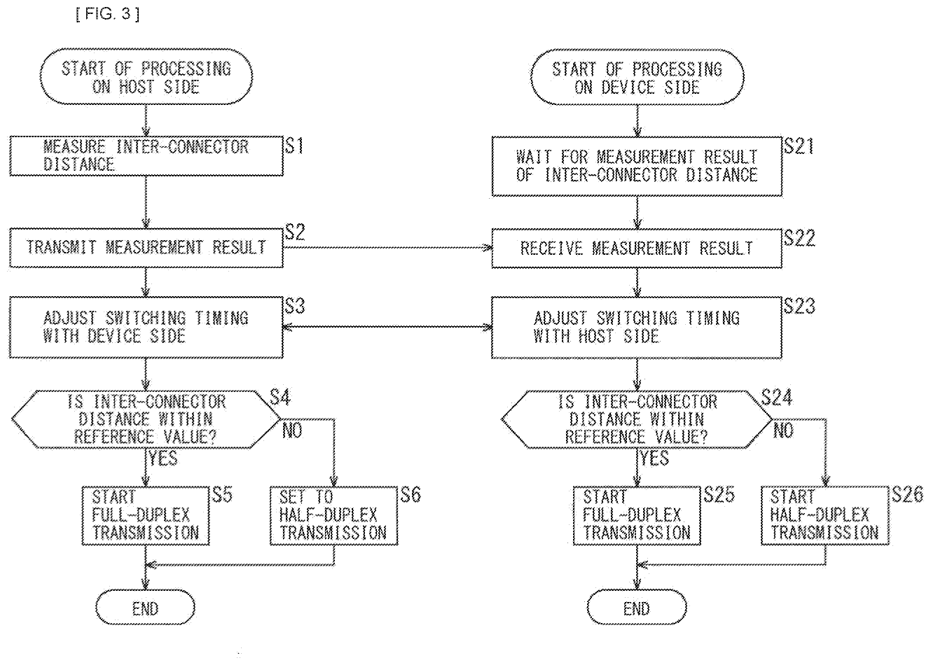

Next, description is given of transmission method control processing to be executed by the communication system 10, with reference to a flowchart illustrated in FIG. 3. It is to be noted that the processing is started at the beginning of communication with the connector 24 of the communication apparatus 11 and the connector 124 of the communication apparatus 12 brought into contact with each other or moved closer to each other, for example.

It is to be noted that, hereinafter, the communication apparatus 11 that performs control of a transmission method in an initiative manner is defined as a host, and the communication apparatus 12 that performs the control of the transmission method in a dependent manner is defined as a device.

In step S1, the distance sensor 26 of the communication apparatus 11 measures an inter-connector distance between the communication apparatus 11 and the communication apparatus 12. The distance sensor 26 supplies a measuring signal indicating a measurement result to the transmission control section 31.

Meanwhile, in step S21, the transmission control section 131 of the communication apparatus 12 waits for the measurement result of the inter-connector distance.

In step S2, the communication apparatus 11 transmits the measurement result. Specifically, the transmission control section 31 generates a signal to notify the measurement result of the inter-connector distance (hereinafter referred to as a measurement result notification signal), and transmits the signal through the transmitting section 23 and the waveguide path 24A.

In step S22, the transmission control section 131 of the communication apparatus 12 receives the measurement result (the measurement result notification signal) through the waveguide path 124B.

In step S3, the communication apparatus 11 adjusts switching timing with device side. Further, in response to processing of step S3, in step S23, the communication apparatus 12 adjusts switching timing with host side. For example, the transmission control section 31 of the communication apparatus 11 and the transmission control section 131 of the communication apparatus 12 transmit/receive a synchronization signal, etc. through the transmitting section 23, the waveguide path 24A, the waveguide path 124B, and the receiving section 125, as well as the transmitting section 123, the waveguide path 124A, the waveguide path 24B, and the receiving section 25 to synchronize the switching timing of the transmission method.

In step S4, the transmission control section 31 of the communication apparatus 11 determines whether or not the inter-connector distance is within a reference value. In a case where the inter-connector distance is determined to be within the reference value, the processing proceeds to step S5.

Likewise, in step S24, the transmission control section 131 of the communication apparatus 12 determines whether or not the inter-connector distance is within the reference value. In a case where the inter-connector distance is determined to be within the reference value, the processing proceeds to step S25.

It is to be noted that the reference value of the inter-connector distance is, for example, set to a distance in which a level of an interference component included in each of signals received by the communication apparatus 11 and the communication apparatus 12 is equal to or less than a predetermined threshold.

In step S5, the transmission control section 31 of the communication apparatus 11 starts full-duplex transmission. In other words, the transmission control section 31 starts control of the transmitting section 23 and the receiving section 25 to perform the full-duplex transmission with the communication apparatus 12.

In synchronization with the processing of step S5, in step S25, the transmission control section 131 of the communication apparatus 12 starts the full-duplex transmission. In other words, the transmission control section 131 starts control of the transmitting section 123 and the receiving section 125 to perform the full-duplex transmission with the communication apparatus 11.

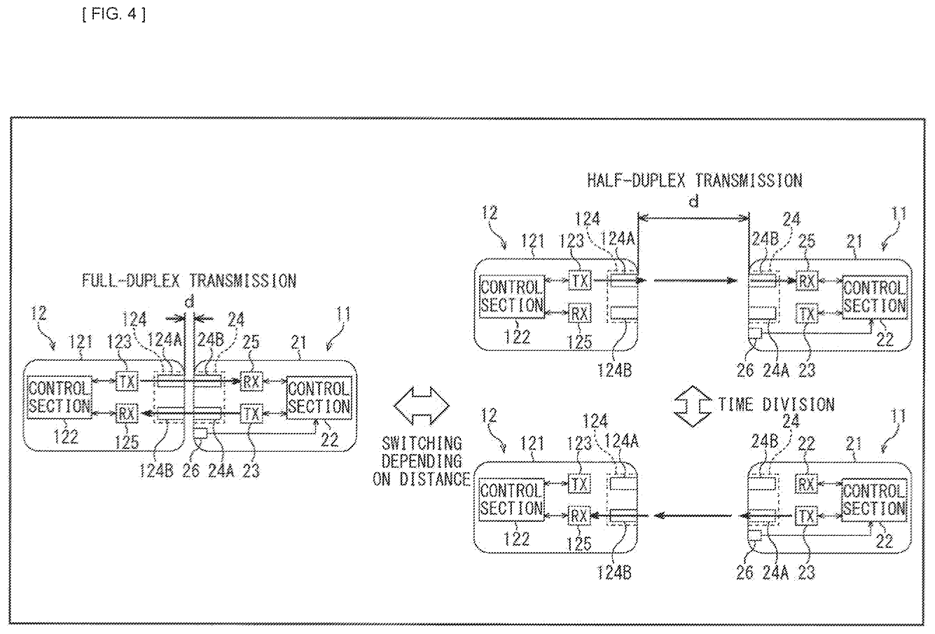

This ensures that the full-duplex transmission is performed between the communication apparatus 11 and the communication apparatus 12 as illustrated on the left side of FIG. 4 in a case where an inter-connector distance d is within the reference value. In other words, transmission of the transmission signal A from the communication apparatus 11 to the communication apparatus 12 and transmission of the transmission signal B from the communication apparatus 12 to the communication apparatus 11 are performed in parallel. At this occasion, the inter-connector distance d is short, and thus leakage of the transmission signal A and the transmission signal B between the communication apparatus 11 and the communication apparatus 12 hardly takes place. Hence, interference between the transmission signal A and the transmission signal B hardly takes place, thus allowing favorable signal quality to be maintained.

Thereafter, the transmission method control processing is ended.

In contrast, in step S4, in a case where the inter-connector distance is determined to exceed the reference value, the processing proceeds to step S6.

Likewise, in step S24, in a case where the inter-connector distance is determined to exceed the reference value, the processing proceeds to step S26.

In step 6, the transmission control section 31 of the communication apparatus 11 starts half-duplex transmission. In other words, the transmission control section 31 starts control of the transmitting section 23 and the receiving section 25 to perform the half-duplex transmission with the communication apparatus 12.

In synchronization with the processing of step S6, in step S26, the transmission control section 131 of the communication apparatus 12 starts the half-duplex transmission. In other words, the transmission control section 131 starts control of the transmitting section 123 and the receiving section 125 to perform the half-duplex transmission with the communication apparatus 11.

This ensures that the half-duplex transmission is performed between the communication apparatus 11 and the communication apparatus 12 as illustrated on the right side of FIG. 4 in a case where the inter-connector distance d exceeds the reference value. In other words, transmission of the transmission signal A from the communication apparatus 11 to the communication apparatus 12 and transmission of the transmission signal B from the communication apparatus 12 to the communication apparatus 11 are performed alternately on a time-division basis. This allows for suppression of occurrence of any interference between the transmission signal A and the transmission signal B maintaining superior even when the inter-connector distance d becomes longer, thus maintaining favorable signal quality.

Thereafter, the transmission method control processing is ended.

It is to be noted that, the inter-connector distance may be measured constantly during signal transmission to switch transmission methods on a real-time basis depending on the inter-connector distance.

### <Modification Example of Combination of Transmission Methods>

The above descriptions give an example of switching between the full-duplex transmission and the half-duplex transmission on the basis of the inter-connector distance; however, it is also possible to change combination of the transmission methods to be switched.

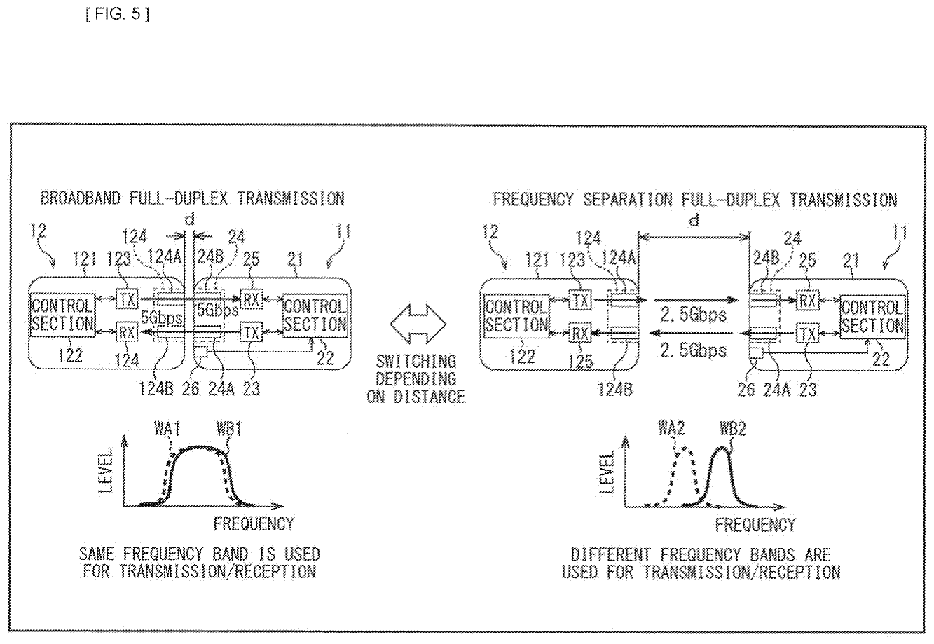

For example, as illustrated in FIG. 5, broadband full-duplex transmission may be performed in a case where the inter-connector distance is equal to or less than the reference value, and frequency separation full-duplex transmission may be performed in a case where the inter-connector distance d is greater than the reference value.

As used herein, the broadband full-duplex transmission refers to performing the full-duplex transmission in such a manner that all of frequency bands assigned for signal transmission between the communication apparatus 11 and the communication apparatus 12 are assigned in common to the transmission signal A and the transmission signal B, for example. Accordingly, in the communication apparatus 11 and the communication apparatus 12, a transmitting frequency and a receiving frequency have the same frequency band.

For example, as illustrated in a graph at the lower left of FIG. 5, substantially the same bands are assigned to a frequency band WA1 of the transmission signal A and a frequency band WB1 of the transmission signal B, and a transmission rate of each of the transmission signal A and the transmission signal B is set at 5 gigabits per second (Gbps). At this occasion, the inter-connector distance d is short, and thus leakage of the transmission signal A and the transmission signal B between the communication apparatus 11 and the communication apparatus 12 hardly takes place. Thus, interference between the transmission signal A and the transmission signal B hardly takes place, thus making it possible to achieve high-speed communication while maintaining favorable signal quality.

Meanwhile, the frequency separation full-duplex transmission refers to performing the full-duplex transmission in such a manner that a maximum frequency band assigned for signal transmission between the communication apparatus 11 and the communication apparatus 12 is divided into two, one of which is assigned to the transmission signal A, and the other is assigned to the transmission signal B. Accordingly, a transmitting frequency and a receiving frequency are separated to hardly overlap each other in the communication apparatus 11 and the communication apparatus 12.

For example, as illustrated in a graph at the lower right of FIG. 5, one frequency band WA2 after division is assigned to the transmission signal A, and the other frequency band WB2 is assigned to the transmission signal B. The transmission rate of each of the transmission signal A and the transmission signal B is set at 2.5 Gbps. Accordingly, even when the inter-connector distance d becomes longer, interference between the transmission signal A and the transmission signal B hardly takes place because of difference in frequency bands of the transmission signal A and the transmission signal B. As a result, favorable signal quality is maintained.

### 3. Second Embodiment

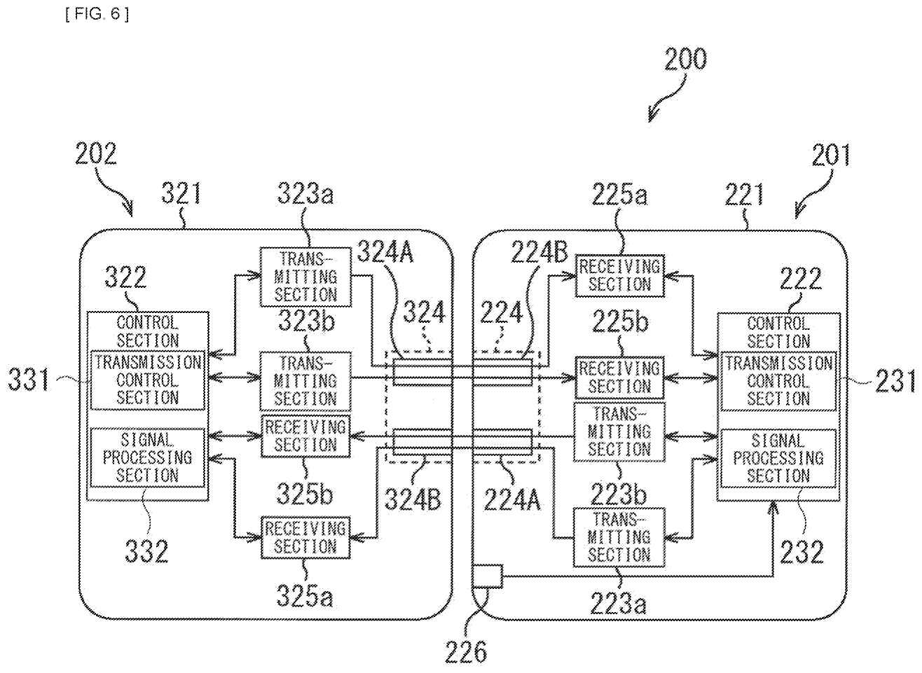

Next, description is given of a second embodiment of the present technology with reference to FIG. 6 to FIG. 8.

### <Configuration Example of Second Embodiment of Communication System>

FIG. 6 is a block diagram illustrating a second embodiment of the communication system to which the present technology is applied.

A communication system 200 illustrated in FIG. 6 includes a communication apparatus 201 and a communication apparatus 202.

The communication apparatus 201 includes a control section 222, a transmitting section 223a, a transmitting section 223b, a connector 224, a receiving section 225a, a receiving section 225b, and a distance sensor 226 inside a housing 221.

The control section 222 is configured by a processor, etc. such as a CPU, for example, and includes a transmission control section 231 and a signal processing section 232 as described above.

The transmission control section 231 controls signal transmission to be performed by the transmitting section 223a, the transmitting section 223b, the receiving section 225a, and the receiving section 225b. For example, on the basis of an inter-connector distance between the connector 224 of the communication apparatus 201 and a connector 324 of the communication apparatus 202 that is measured by the distance sensor 226, the transmission control section 231 controls the transmitting section 223a, the transmitting section 223b, the receiving section 225a, and the receiving section 225b to switch transmission methods of the communication apparatus 201.

The signal processing section 232 performs a variety of signal processing operations. For example, the signal processing section 232 acquires from the receiving section 225a and the receiving section 225b a signal received from the communication apparatus 202 to perform various types of processing operation on the basis of the acquired signal.

The transmitting section 223a modulates a signal supplied from the control section 222 in a method similar to the method performed by the transmitting section 23 in FIG. 1. The transmitting section 223a transmits the post-modulation transmission signal to the communication apparatus 202 through a waveguide path 224A of the connector 224.

The transmitting section 223b modulates a signal supplied from the control section 222 in a method similar to the method performed by the transmitting section 23 in FIG. 1. The transmitting section 223b transmits the post-modulation transmission signal to the communication apparatus 202 through a waveguide path 224A of the connector 224.

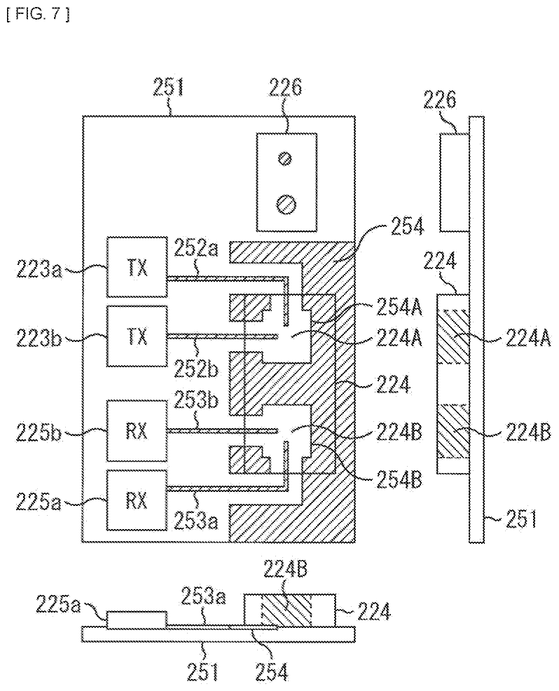

The connector 224 is provided with the waveguide path 224A and a waveguide path 224B. Further details of the connector 224, the waveguide path 224A, and the waveguide path 224B are described later with reference to FIG. 7.

The receiving section 225a receives a transmission signal from the communication apparatus 202 through the waveguide path 224B of the connector 224. As with the receiving section 25 of the communication apparatus 11 in FIG. 1, the receiving section 225a demodulates the received transmission signal into a pre-modulation signal. The receiving section 225a supplies a post-demodulation signal to the control section 222.

The receiving section 225b receives a transmission signal from the communication apparatus 202 through the waveguide path 224B of the connector 224. As with the receiving section 25 of the communication apparatus 11 in FIG. 1, the receiving section 225b demodulates the received transmission signal into a pre-modulation signal. The receiving section 225b supplies a post-demodulation signal to the control section 222.

The communication apparatus 202 includes a control section 322, a transmitting section 323a, a transmitting section 323b, a connector 324, a receiving section 325a, and a receiving section 325b inside a housing 321. The control section 322 includes a transmission control section 331 and a signal processing section 332. The connector 324 includes a waveguide path 324A and a waveguide path 324B.

It is to be noted that, in the communication apparatus 202, any components corresponding to those in the communication apparatus 201 are denoted by the same reference numerals in the last two digits. The communication apparatus 202 has a configuration eliminating the distance sensor 226 from the communication apparatus 201, and other components are almost similar to those in the communication apparatus 201. Therefore, detailed descriptions are omitted.

FIG. 7 corresponds to a plan view, a front view, and a right side view illustrating, in a schematic manner, a specific configuration in the vicinity of the transmitting section 223a, the transmitting section 223b, the connector 224, the receiving section 225a, the receiving section 225b, and the distance sensor 226 of the communication apparatus 201. It is to be noted that orientation of the communication apparatus 201 in the plan view illustrated in FIG. 7 is equivalent to orientation of the communication apparatus 201 in FIG. 6 being rotated by 180 degrees. Further, a positional relationship among the respective components in the communication apparatus 201 is described below on the basis of a vertical direction and a horizontal direction of the plan view.

In the communication apparatus 201, the transmitting section 223a, the transmitting section 223b, the receiving section 225b, and the receiving section 225a are disposed on a substrate 251 in line in the vertical direction. Further, the connector 224 is disposed on right side of a row of the transmitting section 223a, the transmitting section 223b, the receiving section 225b, and the receiving section 225a. The distance sensor 226 is disposed in the vicinity of the connector 224 and above the connector 224.

The connector 224 is made of, for example, metal such as aluminum. Further, the connector 224 includes the waveguide path 224A and the waveguide path 224B that are disposed in line in the vertical direction. The waveguide path 224A and the waveguide path 224B are each made of a rectangular hole extending vertically relative to the substrate 251.

It is to be noted that the waveguide path 224A and the waveguide path 224B are filled with a dielectric on an as-needed basis. Examples of the dielectric to be used include polytetrafluoroethylene, liquid crystalline polymer, cycloolefin polymer, polyimide, polyether ether ketone, polyphenylene sulfide, a thermosetting resin, and an ultraviolet curable resin. It is to be noted that a whole of each of the waveguide paths does not necessarily need to be filled with the dielectric, and it is sufficient that at least a portion of each of the waveguide paths, preferably at least an open end of each of the waveguide paths may be filled.

The transmitting section 223a and the waveguide path 224A are coupled to each other by a microstrip line 252a. The microstrip line 252a extends from the outside of the connector 224 to a region close to the center of the waveguide path 224A (an opening 254A of a pattern 254) in the vertical direction. The microstrip line 252a inside the waveguide path 224A allows for transmission (excitation) of a vertical polarized wave (a TE10 mode). The transmitting section 223b and the waveguide path 224A are coupled to each other by a microstrip line 252b. The microstrip line 252b extends from the outside of the connector 224 to a region close to the center of the waveguide path 224A (the opening 254A of the pattern 254) in the horizontal direction. The microstrip line 252b inside the waveguide path 224A allows for transmission (excitation) of a horizontal polarized wave (a TE01 mode).

This ensures that a transmission signal from the transmitting section 223a and a transmission signal from the transmitting section 223b are sent from the waveguide path 224A in the form of the polarized waves that are orthogonal to each other. In other words, the transmission signal from the transmitting section 223a is sent in the form of the vertical polarized wave through the microstrip line 252a and the waveguide path 224A. The transmission signal from the transmitting section 223b is sent in the form of the horizontal polarized wave through the microstrip line 252b and the waveguide path 224A.

The waveguide path 224A and the receiving section 225a are coupled to each other by a microstrip line 253a. The microstrip line 253a extends from the outside of the connector 224 to a region close to the center of the waveguide path 224B (an opening 254B of the pattern 254) in the vertical direction. The microstrip line 253a inside the waveguide path 224B allows for reception of the vertical polarized wave (the TE10 mode). The waveguide path 224A and the receiving section 225b are coupled to each other by a microstrip line 253b. The microstrip line 253b extends from the outside of the connector 224 to a region close to the center of the waveguide path 224B (the opening 254B of the pattern 254) in the horizontal direction. The microstrip line 253b inside the waveguide path 224B allows for reception of the horizontal polarized wave (the TE01 mode).

This ensures that the receiving section 225a and the receiving section 225b receive transmission signals in the form of the polarized waves that are orthogonal to each other. For example, the receiving section 225a receives a transmission signal sent in the form of the vertical polarized wave through the waveguide path 224B and the microstrip line 253a. The receiving section 225b receives a transmission signal sent in the form of the horizontal polarized wave through the waveguide path 224B and the microstrip line 253b.

The pattern 254 on the substrate 251 is provided with the opening 254A and opening 254B that are rectangular to match shapes of the waveguide path 224A and the waveguide path 224B, respectively. The pattern 254 is grounded.

It is to be noted that a configuration in the vicinity of the transmitting section 323a, the transmitting section 323b, the connector 324, the receiving section 325a, and the receiving section 325b of the communication apparatus 202 is almost similar to the configuration illustrated in FIG. 7 with the exception that no distance sensor is provided.

The housing 221 of the communication apparatus 201 and the housing 321 of the communication apparatus 202 are brought into contact with each other or moved closer to each other, and a contact surface of the connector 224 of the communication apparatus 201 and a contact surface of the connector 324 of the communication apparatus 202 are brought into contact with each other or moved closer to each other. This causes the connector 224 and the connector 324 to be coupled electromagnetically. This allows for signal transmission between the connector 224 and the connector 324.

More particularly, an open end of the waveguide path 224A provided on the contact surface of the connector 224 and an open end of the waveguide path 324B provided on the contact surface of the connector 324 are brought into contact with each other or moved closer to each other. This causes the waveguide path 224A and the waveguide path 324B to be coupled electromagnetically, which allows for signal transmission between the waveguide path 224A and the waveguide path 324B. Likewise, an open end of the waveguide path 224B provided on the contact surface of the connector 224 and an open end of the waveguide path 324A provided on the contact surface of the connector 324 are brought into contact with each other or moved closer to each other. This causes the waveguide path 224B and the waveguide path 324A to be coupled electromagnetically, which allows for signal transmission between the waveguide path 224B and the waveguide path 324A.

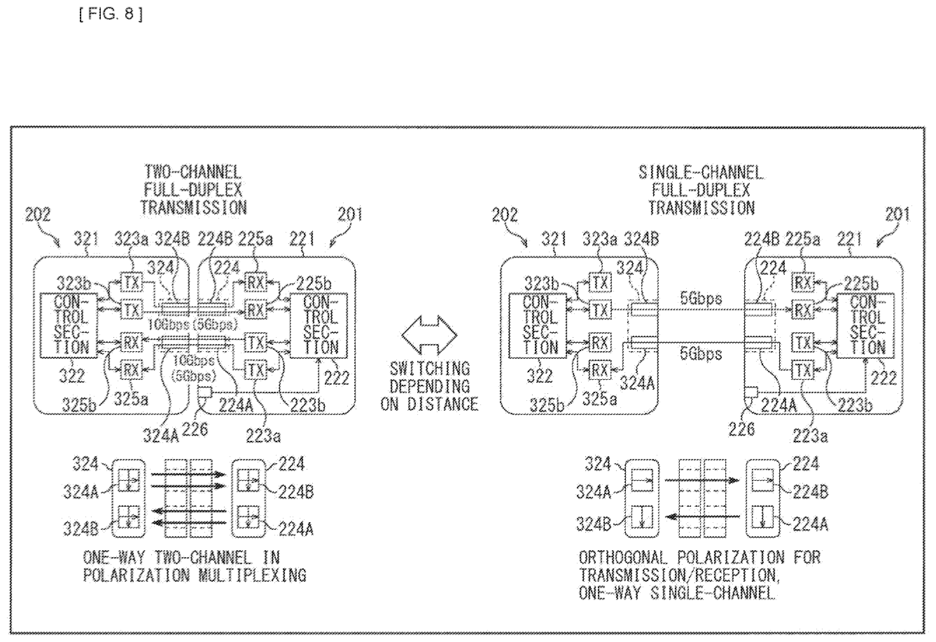

Here, as illustrated in FIG. 8, the communication system 200 makes switching between two-channel full-duplex transmission and single-channel full-duplex transmission on the basis of an inter-connector distance between the communication apparatus 201 and the communication apparatus 202. In other words, the two-channel full-duplex transmission is performed in a case where the inter-connector distance is equal to or less than a reference value, and the single-channel full-duplex transmission is performed in a case where the inter-connector distance is greater than the reference value.

As used herein, the two-channel full-duplex transmission refers to transmitting two-channel transmission signals concurrently in both directions through polarization multiplexing. In other words, two-channel transmission signal A1 and transmission signal A2 are transmitted from the communication apparatus 201 to the communication apparatus 202 concurrently through the polarization multiplexing of a vertical polarized wave and a horizontal polarized wave. Further, two-channel transmission signal B1 and transmission signal B2 are transmitted from the communication apparatus 202 to the communication apparatus 201 concurrently through the polarization multiplexing of the vertical polarized wave and the horizontal polarized wave. For example, a transmission rate of each of the transmission signals is set to 5 Gbps.

The transmission signal A1 and transmission signal A2 are transmitted in the form of polarized waves that are orthogonal to each other, and thus interference hardly takes place. Likewise, the transmission signal B1 and transmission signal B2 are transmitted in the form of the polarized waves that are orthogonal to each other, and thus interference hardly takes place. Further, the inter-connector distance is short, and thus interference hardly takes place between the transmission signal A1 and transmission signal A2, as well as between the transmission signal B1 and transmission signal B2.

Meanwhile, the single-channel full-duplex transmission refers to transmitting single-channel transmission signals concurrently in both directions. At this occasion, a transmission signal A to be transmitted from the communication apparatus 201 to the communication apparatus 202 and a transmission signal B to be transmitted from the communication apparatus 202 to the communication apparatus 201 are sent in the form of the polarized waves that are orthogonal to each other. For example, the transmission signal A is transmitted in the form of the vertical polarized wave, and the transmission signal B is transmitted in the form of the horizontal polarized wave. Accordingly, even when the inter-connector distance becomes longer, interference hardly takes place between the transmission signal A and the transmission signal B.

### 4. Third Embodiment

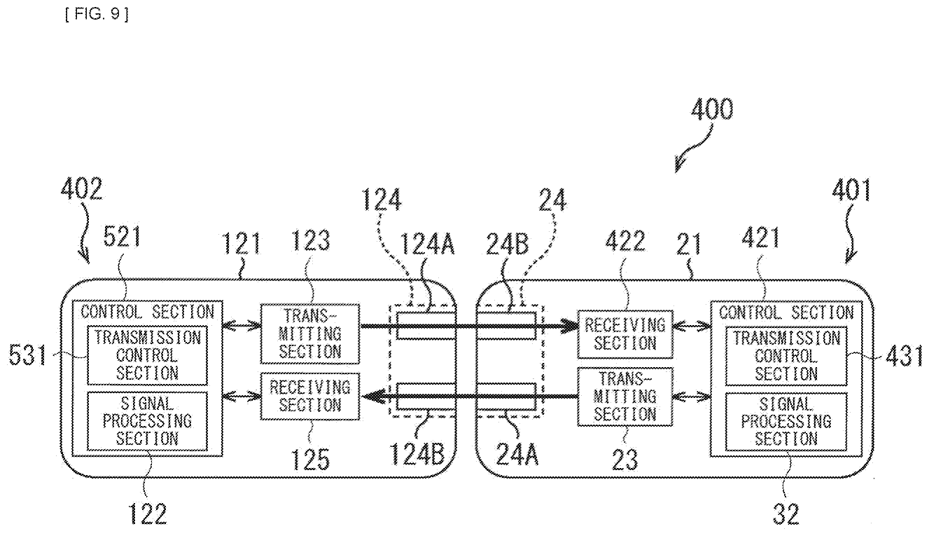

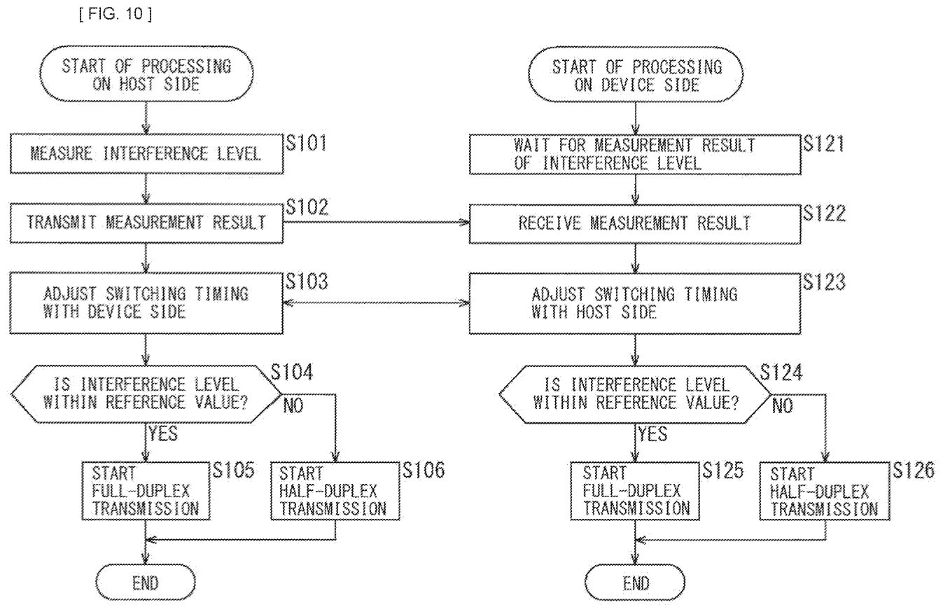

Next, description is given of a third embodiment of the present technology with reference to FIG. 9 and FIG. 10.

### <Configuration Example of Third Embodiment of Communication System>

FIG. 9 is a block diagram illustrating a third embodiment of the communication system to which the present technology is applied. It is to be noted that, in FIG. 9, components corresponding to those in FIG. 1 are denoted by the same reference numerals, and descriptions thereof are omitted where appropriate.

A communication system 400 in FIG. 9 differs from the communication system 10 in FIG. 1 in that a communication apparatus 401 and a communication apparatus 402 are provided in place of the communication apparatus 11 and the communication apparatus 12. The communication apparatus 401 differs from the communication apparatus 11 in that a control section 421 and a receiving section 422 are provided in place of the control section 22 and the receiving section 25 and that the distance sensor 26 is eliminated. The control section 421 differs from the control section 22 in that a transmission control section 431 is provided in place of the transmission control section 31. The communication apparatus 402 differs from the communication apparatus 12 in that a control section 521 is provided in place of the control section 122. The control section 521 differs from the control section 122 in that a transmission control section 531 is provided in place of the transmission control section 131.

The receiving section 422 receives a transmission signal from the communication apparatus 402 through the waveguide path 24B. As with the receiving section 25 in FIG. 1, the receiving section 422 demodulates the received transmission signal into a pre-modulation signal. The receiving section 422 supplies a post-demodulation signal to the control section 421.

Further, the receiving section 422 measures a level of an interference component (hereinafter referred to as an interference level) that is included in the transmission signal received through the waveguide path 24B. The receiving section 422 supplies a measuring signal indicating a measurement result of the interference level to the transmission control section 431.

The transmission control section 431 controls signal transmission to be performed by the transmitting section 23 and the receiving section 422. For example, on the basis of the interference level measured by the receiving section 422, the transmission control section 431 controls the transmitting section 23 and the receiving section 422 to switch transmission methods of the communication apparatus 401.

The transmission control section 531 controls signal transmission to be performed by the transmitting section 123 and the receiving section 125. For example, on the basis of an interference level measured by the communication apparatus 401, the transmission control section 531 controls the transmitting section 123 and the receiving section 125 to switch transmission methods of the communication apparatus 402.

### <Transmission Method Control Processing>

Next, description is given of transmission method control processing to be executed by the communication system 400, with reference to a flowchart illustrated in FIG. 10. It is to be noted that the processing is started at the beginning of communication with the connector 24 of the communication apparatus 401 and the connector 124 of the communication apparatus 12 brought into contact with each other or moved closer to each other, for example.

It is to be noted that, hereinafter, the communication apparatus 401 that performs control of a transmission method in an initiative manner is defined as a host, and the communication apparatus 402 that performs the control of the transmission method in a dependent manner is defined as a device.

In step S101, the receiving section 422 of the communication apparatus 401 measures an interference level. Specifically, the receiving section 422 measures a level of an interference component included in a signal received through the waveguide path 24B, and supplies a measuring signal indicating a measurement result to the transmission control section 431.

Meanwhile, in step S121, the transmission control section 531 of the communication apparatus 402 waits for the measurement result of the interference level.

In step S102, the communication apparatus 401 transmits the measurement result to the communication apparatus 402, as with the processing of step S2 in FIG. 3.

In step S122, the communication apparatus 402 receives the measurement result, as with the processing of step S22 in FIG. 3.

In step S103 and step S123, the switching timing is adjusted between the device side (the communication apparatus 401) and the host side (the communication apparatus 402), as with the processing of step S3 and step S23 in FIG. 3.

In step S104, the transmission control section 431 of the communication apparatus 401 determines whether or not the interference level is within a reference value. In a case where the interference level is determined to be within the reference value, the processing proceeds to step S105.

Likewise, in step S124, the transmission control section 531 of the communication apparatus 402 determines whether or not the interference level is within the reference value. In a case where the interference level is determined to be within the reference value, the processing proceeds to step S125.

It is to be noted that the reference value of the interference level is, for example, set to a level to such an extent as not to cause any problem to quality of a transmission signal to be transmitted between the communication apparatus 401 and the communication apparatus 402.

In step 105, the communication apparatus 401 starts the full-duplex transmission, as with the processing of step S5 in FIG. 3.

Further, in synchronization with the processing of step S105, in step S125, the communication apparatus 402 starts the full-duplex transmission, as with the processing of step S25 in FIG. 3.

Thereafter, the transmission method control processing is ended.

In contrast, in step S104, in a case where the interference level is determined to exceed the reference value, the processing proceeds to step S106.

Further, in step S124, in a case where the inter-connector distance is determined to exceed the reference value, the processing proceeds to step S126.

In step 106, the communication apparatus 401 starts the half-duplex transmission, as with the processing of step S6 in FIG. 3.

Further, in synchronization with the processing of step S106, in step S126, the communication apparatus 402 starts the half-duplex transmission, as with the processing of step S26 in FIG. 3.

Thereafter, the transmission method control processing is ended.

In such a manner, it is possible to properly switch transmission methods on the basis of the interference level instead of the inter-connector distance.

### 5. Modification Examples

Although the preferred embodiments of the present technology are described above, the present technology is not limited to the above-described embodiments, and various modifications or improvements may be made to the above-described embodiments insofar as they are within the scope of the gist of the present technology.

For example, in the communication system 400 in FIG. 9, on the basis of the interference level, switching between the broadband full-duplex transmission and the frequency separation full-duplex transmission may be made as illustrated in FIG. 5.

Further, for example, the switching between the two-channel full-duplex transmission and the single-channel full-duplex transmission as illustrated in FIG. 8 may be made on the basis of the interference level.

Additionally, for example, in the communication system 400 in FIG. 9, a right-handed circularly polarized wave and a left-handed circularly polarized wave may be used in place of the vertical polarized wave and the horizontal polarized wave.

Moreover, the present technology is applicable in a case where bidirectional transmission is performed through the electromagnetic coupling with housings of two communication apparatuses brought into contact with each other or moved closer to each other using a method other than a waveguide. For example, the present technology is applicable in a case where the bidirectional transmission is performed through the electromagnetic coupling with the housings of the two communication apparatuses brought into contact with each other or moved closer to each other without using the connectors.

Further, for example, the distance sensor 26 in FIG. 1 may be provided inside the connector 24. In addition, for example, the distance sensor 226 in FIG. 6 may be provided inside the connector 224. Moreover, for example, distance sensors may be provided on both communication apparatuses.

Additionally, for example, in the third embodiment, a sensor that measures an interference level may be provided separately from the receiving section.

### 6. Specific Examples of Communication System

Possible conceivable combinations of electronic apparatuses using the communication apparatus 11 and the communication apparatus 12, the communication apparatus 201 and the communication apparatus 202, or the communication apparatus 401 and the communication apparatus 402 include the following combinations. However, the following combinations are merely exemplified, and the combinations of the electronic apparatuses are not limited to those combinations.

A combination is conceivable, in which the communication apparatus 12, the communication apparatus 202, or the communication apparatus 402 serves as a battery-powered apparatus such as a mobile phone, a digital camera, a video camera, a game machine, and a remote controller, whereas the communication apparatus 11, the communication apparatus 201, or the communication apparatus 401 serves as an apparatus referred to as a so-called base station that performs battery charging, image processing, etc. Further, a combination is conceivable, in which the communication apparatus 12, the communication apparatus 202, or the communication apparatus 402 serves as an apparatus having a relatively thin appearance, such as an IC card, whereas the communication apparatus 11, the communication apparatus 201, or the communication apparatus 401 serves as a card reader/writer thereof. The card reader/writer is further used in combination, for example, with a main unit of any of electronic apparatuses such as a digital recorder/reproducer, a terrestrial television receiver, a mobile phone, a game machine, and a computer.

Further, a combination of a mobile terminal apparatus and a cradle is also possible. The cradle is a stand-type expansion unit that performs charging, data transfer, or expansion for the mobile terminal apparatus. In the communication system employing the system configuration as described above, the communication apparatus 11, the communication apparatus 201, or the communication apparatus 401 serves as the cradle. Further, the communication apparatus 12, the communication apparatus 202, or the communication apparatus 402 serve as the mobile terminal apparatus.

It is to be noted that the present technology may have the following configurations.

(1)

A communication apparatus including a transmission control section that controls a method of transmission with another communication apparatus that performs bidirectional transmission through electromagnetic coupling on a basis of a distance from the other communication apparatus.

(2)

The communication apparatus according to (1), in which the transmission control section makes switching between full-duplex transmission and half-duplex transmission on the basis of the distance from the other communication apparatus.

(3)

The communication apparatus according to (1), in which the transmission control section makes switching, on the basis of the distance from the other communication apparatus, between full-duplex transmission in which a transmitting frequency and a receiving frequency are in same predetermined frequency band and full-duplex transmission in which a transmitting frequency and a receiving frequency are separated within the predetermined frequency band.

(4)

The communication apparatus according to (1), in which the transmission control section makes switching, on the basis of the distance from the other communication apparatus, between full-duplex transmission that transmits a two-channel signal using a first polarized wave and a second polarized wave that differ from each other and receives a two-channel signal using the first polarized wave and the second polarized wave, and full-duplex transmission that transmits a single-channel signal using the first polarized wave and receives a single-channel signal using the second polarized wave.

(5)

The communication apparatus according to any one of (1) to (4), including:

a connector;

a transmitting section that performs signal transmission through the connector; and

a receiving section that performs signal reception through the connector, in which the transmission control section controls a method of transmission with the other communication apparatus on a basis of a distance between the connector and a connector of the other communication apparatus.

(6)

The communication apparatus according to (5), in which

the connector includes a waveguide that includes a first waveguide path and a second waveguide path,

the transmitting section performs signal transmission through the first waveguide path, and

the receiving section performs signal reception through the second waveguide path.

(7)

The communication apparatus according to any one of (1) to (6), further including a measuring section that measures the distance from the other communication apparatus.

(8)

The communication apparatus according to any one of (1) to (7), in which a signal to be transmitted to and from the other communication apparatus is a millimeter-wave band signal.

(9)

A communication method including causing a communication apparatus to control a method of transmission with another communication apparatus that performs bidirectional transmission through electromagnetic coupling on a basis of a distance from the other communication apparatus.

(10)

An electronic apparatus including a transmission control section that controls a method of transmission with another communication apparatus that performs bidirectional transmission through electromagnetic coupling on a basis of a distance from the other communication apparatus.

(11)

A communication apparatus including a transmission control section that controls a method of transmission with another communication apparatus on a basis of an interference level that is a level of an interference component of a first signal affecting a second signal in a case of performing transmission of the first signal and reception of the second signal through electromagnetic coupling with the other communication apparatus.

(12)

The communication apparatus according to (11), in which the transmission control section makes switching between full-duplex transmission and half-duplex transmission on the basis of the interference level.

(13)

The communication apparatus according to (11), in which the transmission control section makes switching, on the basis of the interference level, between full-duplex transmission in which a transmitting frequency and a receiving frequency are in same predetermined frequency band and full-duplex transmission in which a transmitting frequency and a receiving frequency are separated within the predetermined frequency band.

(14)

The communication apparatus according to (11), in which the transmission control section makes switching, on the basis of the interference level, between full-duplex transmission that transmits a two-channel signal using a first polarized wave and a second polarized wave that differ from each other and receives a two-channel signal using the first polarized wave and the second polarized wave, and full-duplex transmission that transmits a single-channel signal using the first polarized wave and receives a single-channel signal using the second polarized wave.

(15)

The communication apparatus according to any one of (11) to (14), including:

a connector;

a transmitting section that performs transmission of the first signal through the connector; and
a receiving section that performs reception of the second signal through the connector.
   (16)

The communication apparatus according to (15), in which

the connector includes a waveguide that includes a first waveguide path and a second waveguide path,

the transmitting section performs signal transmission through the first waveguide path, and

the receiving section performs signal transmission through the second waveguide path.

(17)

The communication apparatus according to (15) or (16), in which the receiving section measures the interference level on a basis of a signal received through the connector.

(18)

The communication apparatus according to any one of (11) to (17), in which a signal to be transmitted to and from the other communication apparatus is a millimeter-wave band signal.

(19)

A communication method including causing a communication apparatus to control a method of transmission with another communication apparatus on a basis of an interference level that is a level of an interference component of a first signal affecting a second signal in a case of performing transmission of the first signal and reception of the second signal through electromagnetic coupling with the other communication apparatus.

(20)

An electronic apparatus including a transmission control section that controls a method of transmission with another communication apparatus on a basis of an interference level that is a level of an interference component of a first signal affecting a second signal in a case of performing transmission of the first signal and reception of the second signal through electromagnetic coupling with the other communication apparatus.

### REFERENCE NUMERALS LIST

10 communication system
11, 12 communication apparatus
22 control section
23 transmitting section
24 connector
24A, 24B waveguide path
25 receiving section
26 distance sensor
31 transmission control section
124 connector
124A, 124B waveguide path
200 communication system
201, 202 communication apparatus
222 control section
223a, 223b transmitting section
224 connector
225a, 225b receiving section
226 distance sensor
231 transmission control section
252a, 252b, 253a, 253b microstrip line
324 connector
324A, 324B waveguide path
400 communication system
401, 402 communication apparatus
421 control section
422 receiving section
431 transmission control section

1. A communication apparatus comprising a transmission control section that controls a method of transmission with another communication apparatus that performs bidirectional transmission through electromagnetic coupling on a basis of a distance from the other communication apparatus.

2. The communication apparatus according to claim 1, wherein the transmission control section makes switching between full-duplex transmission and half-duplex transmission on the basis of the distance from the other communication apparatus.

3. The communication apparatus according to claim 1, wherein the transmission control section makes switching, on the basis of the distance from the other communication apparatus, between full-duplex transmission in which a transmitting frequency and a receiving frequency are in same predetermined frequency band and full-duplex transmission in which a transmitting frequency and a receiving frequency are separated within the predetermined frequency band.

4. The communication apparatus according to claim 1, wherein the transmission control section makes switching, on the basis of the distance from the other communication apparatus, between full-duplex transmission that transmits a two-channel signal using a first polarized wave and a second polarized wave that differ from each other and receives a two-channel signal using the first polarized wave and the second polarized wave, and full-duplex transmission that transmits a single-channel signal using the first polarized wave and receives a single-channel signal using the second polarized wave.

5. The communication apparatus according to claim 1, comprising:
a connector;
a transmitting section that performs signal transmission through the connector; and
a receiving section that performs signal reception through the connector, wherein the transmission control section controls a method of transmission with the other communication apparatus on a basis of a distance between the connector and a connector of the other communication apparatus.

6. The communication apparatus according to claim 5, wherein
the connector comprises a waveguide that includes a first waveguide path and a second waveguide path,
the transmitting section performs signal transmission through the first waveguide path, and
the receiving section performs signal reception through the second waveguide path.

7. The communication apparatus according to claim 1, further comprising a measuring section that measures the distance from the other communication apparatus.

8. The communication apparatus according to claim 1, wherein a signal to be transmitted to and from the other communication apparatus is a millimeter-wave band signal.

9. A communication method comprising causing a communication apparatus to control a method of transmission with another communication apparatus that performs bidirectional transmission through electromagnetic coupling on a basis of a distance from the other communication apparatus.

10. An electronic apparatus comprising a transmission control section that controls a method of transmission with another communication apparatus that performs bidirectional transmission through electromagnetic coupling on a basis of a distance from the other communication apparatus.

11. A communication apparatus comprising a transmission control section that controls a method of transmission with another communication apparatus on a basis of an interference level that is a level of an interference component of a first signal affecting a second signal in a case of performing transmission of the first signal and reception of the second signal through electromagnetic coupling with the other communication apparatus.

12. The communication apparatus according to claim 11, wherein the transmission control section makes switching between full-duplex transmission and half-duplex transmission on the basis of the interference level.

13. The communication apparatus according to claim 11, wherein the transmission control section makes switching, on the basis of the interference level, between full-duplex transmission in which a transmitting frequency and a receiving frequency are in same predetermined frequency band and full-duplex transmission in which a transmitting frequency and a receiving frequency are separated within the predetermined frequency band.

14. The communication apparatus according to claim 11, wherein the transmission control section makes switching, on the basis of the interference level, between full-duplex transmission that transmits a two-channel signal using a first polarized wave and a second polarized wave that differ from each other and receives a two-channel signal using the first polarized wave and the second polarized wave, and full-duplex transmission that transmits a single-channel signal using the first polarized wave and receives a single-channel signal using the second polarized wave.

15. The communication apparatus according to claim 11, comprising:
a connector;
a transmitting section that performs transmission of the first signal through the connector; and
a receiving section that performs reception of the second signal through the connector.

16. The communication apparatus according to claim 15, wherein
the connector comprises a waveguide that includes a first waveguide path and a second waveguide path,
the transmitting section performs signal transmission through the first waveguide path, and
the receiving section performs signal transmission through the second waveguide path.

17. The communication apparatus according to claim 15, wherein the receiving section measures the interference level on a basis of a signal received through the connector.

18. The communication apparatus according to claim 11, wherein a signal to be transmitted to and from the other communication apparatus is a millimeter-wave band signal.

19. A communication method comprising causing a communication apparatus to control a method of transmission with another communication apparatus on a basis of an interference level that is a level of an interference component of a first signal affecting a second signal in a case of performing transmission of the first signal and reception of the second signal through electromagnetic coupling with the other communication apparatus.

20. An electronic apparatus comprising a transmission control section that controls a method of transmission with another communication apparatus on a basis of an interference level that is a level of an interference component of a first signal affecting a second signal in a case of performing transmission of the first signal and reception of the second signal through electromagnetic coupling with the other communication apparatus.
